(19) United States
(12) Patent Application Publication
(10) Pub. No.: US 2013/0152564 A1
(43) Pub. Date: Jun. 20, 2013

(54) ELECTRONIC HILL HOLD CONTROL OF A HYDROSTATIC TRANSMISSION

(71) Applicants: Bryon P. Neumann, Brantford (CA); Chris J. McDonald, Dubuque, IA (US); Mark E. Breutzman, Potosi, WI (US)

(72) Inventors: Bryon P. Neumann, Brantford (CA); Chris J. McDonald, Dubuque, IA (US); Mark E. Breutzman, Potosi, WI (US)

(21) Appl. No.: 13/328,084

(22) Filed: Dec. 16, 2011

(51) Int. Cl. F15B 13/02; F15B 13/16

(52) U.S. Cl. 60/327; 60/455

(57) ABSTRACT

A hill hold control system and method for a closed loop transmission of a machine is disclosed that includes performing the following steps while the transmission is in neutral: sensing motor shaft movement; and generating fluid flow to offset motor shaft movement and cause substantially zero shaft movement. The method can include comparing a brake timer to a delay value, and activating a brake when the timer exceeds the delay value. The method can include sensing when a brake is applied, and discontinuing the step of generating fluid flow to offset motor shaft movement when a brake is applied. Motor shaft movement can be sensed by sensing rotational speed. Generating fluid flow to offset motor shaft movement can include determining direction and magnitude of fluid flow as a function of the sensed movement; and adjusting the direction and magnitude of fluid flow based on recurring readings of the sensed movement.

### FIELD OF THE INVENTION

The present invention generally relates to the field of hydrostatic transmissions and more specifically to a system that can electronically hold a machine with a hydrostatic transmission at zero speed on a slope when the transmission is in neutral.

### BACKGROUND OF THE INVENTION

When a machine with a hydrostatic transmission is in neutral on slopes, there is a tendency for it to ‘drift’ down the hill due to hydraulic leakage in the system. This leakage allows for a non-zero flow across the motor when the pump displacement is commanded to neutral. To minimize the drift of a machine with a hydrostatic transmission, operators tend to use dynamic braking by applying the static parking brake while the machine is drifting. This stops the drift but shortens the life span of the brakes.

Alternative hydraulic systems, such as open loop transmissions, often utilize counterbalance valves incorporated directly inside the track motor to minimize drift. Counterbalance valves accomplish this feature by maintaining a differential pressure on the travel motors with minimal leakage and therefore prevent noticeable motion or drift. This is generally a hydraulic solution and does not utilize electronic control. Counterbalance valves are undesirable in hydrostatic systems because of the added pressure drop and efficiency loss. Open loop systems can also introduce multifunction interference issues when multiple hydraulic systems request more flow than the pump for the open loop system can provide. Typically closed loop, hydrostatic systems are utilized where increased tractive effort and efficiency is a priority.

It would be desirable to have a system that can electronically hold a machine with a hydrostatic transmission at zero speed when the transmission is in neutral on slopes so that the machine does not drift. Being able to drive machines to zero speed on slopes can also reduce the need for dynamic braking on the machines (applying the static park brake while the machine is drifting) which will improve the brake life of the machines.

### SUMMARY

A closed loop transmission and hill hold system for a machine is disclosed that includes a pump, a motor, a fluid leakage path between the motor and the pump, a motor shaft, a motor shaft sensor and a neutral sensor. The pump generates fluid flow and the motor is powered by the fluid flow from the pump. The motor shaft is coupled to the motor such that the motor rotates the motor shaft when powered by the fluid flow from the pump and the motor shaft rotates when an external torque is applied to the motor shaft. The motor shaft sensor detects movement of the motor shaft. The neutral sensor detects when the transmission is commanded to a neutral position. When the transmission is in the neutral position, the pump is not commanded by the transmission to generate fluid flow. When the neutral sensor detects the transmission is in the neutral position, the hill hold system can monitor the motor shaft sensor and command the pump to generate fluid flow in a direction and with a magnitude to cause the motor shaft to be stationary. The hill hold system can continuously monitor the motor shaft sensor and adjust the fluid flow. The motor shaft sensor can detect a rotational speed of the motor shaft, and when the neutral sensor detects the transmission is in the neutral position, the hill hold system can command the pump to generate fluid flow to cause the motor shaft to have a rotational speed of substantially zero.

The closed loop transmission and hill hold system can also include a parking brake timer and a parking brake delay value. The hill hold system can start the parking brake timer when the neutral sensor initially detects that the transmission is in the neutral position, and the hill hold system can activate the parking brake when the parking brake timer is greater than the parking brake delay value.

The closed loop transmission and hill hold system can include a parking brake sensor that detects when a parking brake is applied to the machine. The hill hold system can be turned off when the parking brake sensor indicates that the parking brake is applied to the machine.

A hill hold control method for a closed loop transmission of a machine is disclosed that includes sensing a neutral command for the transmission; and performing the following steps while the neutral command is sensed: sensing movement of a motor shaft; generating fluid flow to offset the movement of the motor shaft; and causing substantially zero movement of the motor shaft. Generating fluid flow to offset the movement of the motor shaft can include determining a direction and magnitude of fluid flow to offset movement of the motor shaft; and activating a pump to generate fluid flow in the determined direction and magnitude. The hill hold control method can maintain substantially zero movement of the motor shaft by repeating the steps of sensing movement; generating fluid flow and causing substantially zero movement.

The hill hold control method can also include starting a brake timer when the neutral command is initially sensed; comparing the brake timer to a brake delay value; and performing the following steps when the brake timer is greater than the brake delay value: activating the parking brake of the machine; and discontinuing maintaining substantially zero movement of the motor shaft by repeating the sensing movement; generating fluid flow and causing substantially zero movement steps. The hill hold control method can also include resetting the brake timer to zero when the parking brake is released or the machine is commanded out of the neutral position.

The hill hold control method can also include sensing when a parking brake is applied to the machine; and when application of the parking brake is sensed; discontinuing the steps to maintain substantially zero movement of the motor shaft.

A hill hold control method for a closed loop transmission of a machine is disclosed that includes sensing a neutral command for the transmission and performing the following steps while the neutral command is sensed: starting a brake timer when the neutral command is initially sensed; sensing movement of a motor shaft; generating fluid flow to offset the movement of the motor shaft and cause substantially zero movement of the motor shaft; comparing the brake timer to a brake delay value; when the brake timer is greater than the brake delay value, activating the parking brake of the machine and discontinuing the step of generating fluid flow to offset the movement of the motor shaft; sensing when a parking brake is applied to the machine; and when application of the parking brake is sensed; discontinuing the step of generating fluid flow to offset the movement of the motor shaft. Sensing movement of the motor shaft can be done by sensing the rotational speed of the motor shaft. The step of generating fluid flow to offset the movement of the motor shaft can include determining a direction and magnitude of fluid flow as a function of the sensed rotational speed of the motor shaft, and adjusting the direction and magnitude of fluid flow based on recurring readings of the sensed rotational speed of the motor shaft.

### BRIEF DESCRIPTION OF THE DRAWINGS

FIG. 1 shows a simplified diagram of a closed loop, hydrostatic transmission circuit that includes a pump, a motor and a leakage path; and

FIG. 2 shows an exemplary control method 200 for a hill hold system.

### DETAILED DESCRIPTION

For the purposes of promoting an understanding of the principles of the novel invention, reference will now be made to the embodiments described herein and illustrated in the drawings and specific language will be used to describe the same. It will nevertheless be understood that no limitation of the scope of the novel invention is thereby intended, such alterations and further modifications in the illustrated devices and methods, and such further applications of the principles of the novel invention as illustrated therein being contemplated as would normally occur to one skilled in the art to which the novel invention relates.

Electronic hill hold can be enabled by a shaft speed sensor that can detect the magnitude and direction of the motor shaft speed. Using this feedback, when a hydrostatic transmission is commanded to neutral and the park brake is not applied, this control system can drive and hold the machine at zero speeds, eliminating drift. Using integral control, this system can drive the machine to zero speed by stroking the pump in the opposite direction of motion and holding the command necessary to achieve zero speed. This control system can be applied to any machine with a closed-loop hydrostatic transmission.

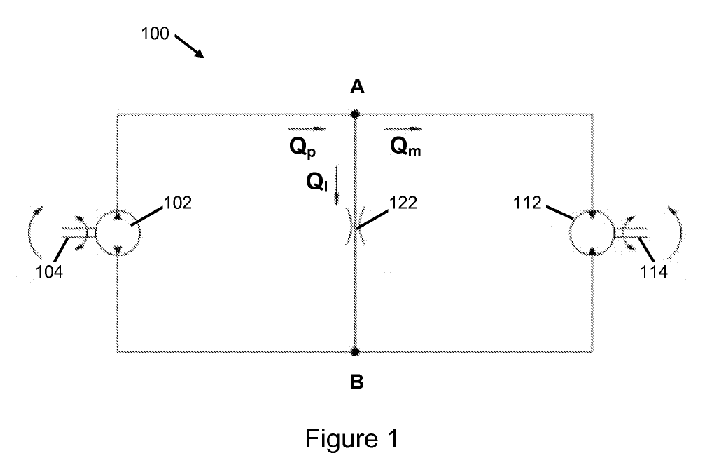

FIG. 1 shows a simplified diagram of a closed loop, hydrostatic transmission circuit 100 that includes a hydrostatic transmission pump 102, a hydrostatic transmission motor 112 and a leakage path 122 that each run between Node A and Node B. The pump 102 is coupled to a pump shaft 104, and the motor 112 is coupled to a motor shaft 114. The root cause and solution of hydrostatic neutral drift can by illustrated through nodal analysis of the simplified system 100. The net oil flow at Node A when the pump is positively stroked is given by the following equation:

ΣQ_{A}=Qₚ−Qₘ−Qₗ=0 (1)

where Qₚ is the flow produced by the hydrostatic pump 102, Qₘ is the flow that is consumed by the hydrostatic motor 112, and Qₗ is a lumped parameter representative of the oil that leaks from various locations through the closed loop system 100 which is illustrated as a single leakage path 122 from Node A to Node B. The leakage path 122 from Node A to Node B represents volumetric inefficiency in the closed loop transmission.

When the hydrostatic pump 102 is returned to the neutral position, Qₚ is zero. If there is a load at the motor 112, it will act to ‘pump’ oil from the motor 112 back into Node A. In this situation, the oil flow at Node A becomes:

ΣQ_{A}=Qₘ−Qₗ=0 (2)

Solving Eq. 2 for a positive leakage flow, the flow across the motor 112 will be equal to this leakage flow. The shaft speed of the motor 112 is given by the equation:

$${N}_{m} = \frac{{Q}_{m}}{{D}_{m}} \qquad ( 3 )$$

where Nₘ is speed of the motor shaft 114 and Dₘ is the displacement per revolution of the motor 112. Therefore, from Eq. 2 and 3, when the pump 102 is in neutral, the flow Qₘ across the motor 112 is approximately the same as the leakage flow Qₗ. Because the hydrostatic motor 112 has a positive displacement, the motor flow Qₘ produces a non-zero shaft speed Nₘ for the motor shaft 114. A motor shaft sensor can be used to detect the movement and/or speed of the motor shaft 114.

Using the relationship between flow and shaft speed in Eq. 3, the detected speed of the motor shaft 114 can be used as a feedback for a closed loop control system. The hydrostatic pump 102 can be stroked to a small displacement to counter the leakage flow Qₗ at Node A. If the pump flow Qₚ into Node A counters the leakage flow Qₗ out of Node A, then the motor flow Qₘ and the movement of the motor shaft 114 will be approximately zero. When the motor shaft 114 is coupled to a track of a machine, the hill hold control system can be used to substantially eliminate perceptible drift of the machine. This is especially true where there is a high gear ratio between the motor shaft 114 and the machine track.

By using the hill hold control, the brake control system for the machine can be simplified. The hill hold control can also extend the brake life of the machine since the brakes, for example friction disc brakes can be applied while the machine is at or close to zero-speed due to the hill hold control as opposed to while the machine is drifting down a hill without the hill hold control.

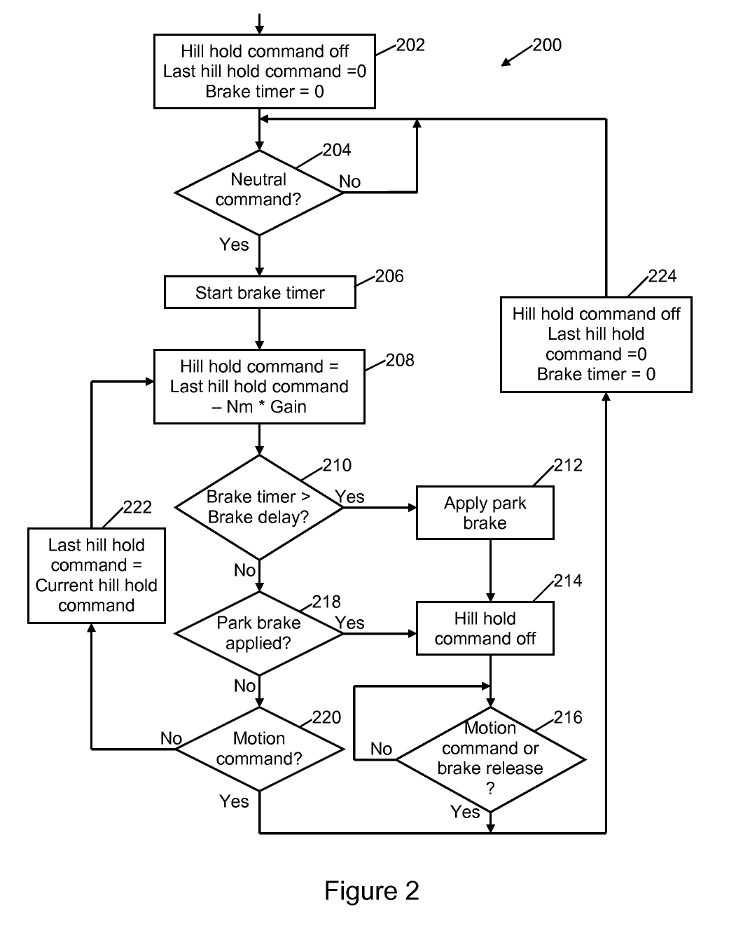

FIG. 2 shows an exemplary control method 200 for the hill hold control system. At block 202, the hill hold command is turned off, the last hill hold command value is set to zero, and the brake timer is set to zero. Then at block 204, the control system waits for the operator to command the machine transmission to neutral. When the transmission is commanded to neutral, control is transferred to block 206.

At block 206, a brake timer is started and control passes to block 208. At block 208, a hill hold command is generated that equals the last hill hold command minus the motor shaft speed times a gain. The motor shaft speed, Nm, can be detected using a sensor. The last hill hold command is initially zero. The motor shaft speed is negative in the computation because the hill hold command value will be in the opposite direction of the motor shaft speed to compensate for the drift. In this way, the control system can compensate for drift whether it is in the forward or backward direction. The gain is selected to help keep the control smooth and stable. As will be understood from the flow diagram 200, for this exemplary embodiment the hill hold command value increases until the motor shaft speed is zero at which point the hill hold command remains steady until the park brake is applied or the operator issues a motion command for the machine. The hill hold command value is a command value to stroke the pump 102 to produce a flow Qₚ into Node A to compensate for the leakage flow Qₗ, making the flow Qₘ through the motor 112 approximately zero. The leakage flow and drift can vary due to many factors, for example, the slope of the hillside, the weight of the machine, the wear of the various system components, etc. However, by sensing the rotation or speed of the motor shaft 114, all of these factors are compensated for regardless of their variations. From block 208 control passes to block 210.

At block 210, the system checks whether the brake timer is greater than a brake delay value. The brake delay value is the delay from when the transmission is commanded to neutral to when the parking brake is applied. An exemplary value of the brake delay can be 10 seconds, and of course the delay can be shorter or longer. When the brake timer is greater than the brake delay value, at block 212 the parking brake is applied, at block 214 the hill hold command is turned off, and at block 216 the control system waits for a motion command or parking brake release by the operator. When the brake timer is not greater than the brake delay value, control passes to block 218.

At block 218, the system checks whether the operator has applied the parking brake. If the parking brake has been applied, at block 214 the hill hold command is turned off, and at block 216 the control system waits for a motion command or parking brake release by the operator. If the parking brake has not been applied, control passes to block 220.

At block 220, the hill hold system is active and the control system checks whether the operator has issued a motion command for the machine. If the operator has not issued a motion command, at block 222 the last hill hold command value is set equal to the current hill hold command value and the control system returns to step 208 to determine if the hill hold command should be modified. If the operator has issued a motion command, control passes to block 224.

At block 216, the hill hold system is off, the parking brake is applied and the control system checks whether the operator has issued a motion command for the machine or has released the parking brake. The control system remains at block 216 until the operator issues a motion command or releases the parking brake. When the operator issues a motion command or releases the parking brake, control passes to block 224.

At block 224, the hill hold command is turned off, the last hill hold command value is set to zero, and the brake timer is set to zero. Then control passes to block 204 where the control system waits for the operator to command the transmission to neutral.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. A closed loop transmission and hill hold system for a machine, the closed loop transmission and hill hold system comprising:
a pump generating fluid flow;
a motor powered by the fluid flow from the pump;
a fluid leakage path between the motor and the pump;
a motor shaft coupled to the motor, the motor rotating the motor shaft when powered by the fluid flow from the pump and the motor shaft rotating when an external torque is applied to the motor shaft;
a motor shaft sensor detecting movement of the motor shaft;
a neutral sensor detecting when the transmission is commanded to a neutral position, the pump not being commanded by the transmission to generate fluid flow when the transmission is in the neutral position;
wherein when the neutral sensor detects the transmission is in the neutral position, the hill hold system monitors the motor shaft sensor and commands the pump to generate fluid flow in a direction and with a magnitude to cause the motor shaft to be stationary.

2. The closed loop transmission and hill hold system of claim 1, wherein while the neutral sensor detects the transmission is in the neutral position, the hill hold system continuously monitors the motor shaft sensor and adjusts the fluid flow generated by the pump to cause the motor shaft to be stationary.

3. The closed loop transmission and hill hold system of claim 1, wherein the motor shaft sensor detects a rotational speed of the motor shaft, and when the neutral sensor detects the transmission is in the neutral position, the hill hold system commands the pump to generate fluid flow to cause the motor shaft to have a rotational speed of substantially zero.

4. The closed loop transmission and hill hold system of claim 3, further comprising:
a parking brake timer; and
a parking brake delay value;
wherein the hill hold system starts the parking brake timer when the neutral sensor detects the transmission is in the neutral position, and the hill hold system activates the parking brake when the parking brake timer is greater than the parking brake delay value.

5. The closed loop transmission and hill hold system of claim 1, further comprising:
a parking brake sensor detecting when a parking brake is applied to the machine;
wherein the hill hold system is turned off when the parking brake sensor indicates that the parking brake is applied to the machine.

6. The closed loop transmission and hill hold system of claim 5, further comprising:
a parking brake timer; and
a parking brake delay value;
wherein the hill hold system starts the parking brake timer when the neutral sensor detects the transmission is in the neutral position, and the hill hold system activates the parking brake when the parking brake timer is greater than the parking brake delay value.

7. A hill hold control method for a closed loop transmission of a machine, the hill hold control method comprising:
sensing a neutral command for the transmission; and
performing the following steps while the neutral command is sensed:
sensing movement of a motor shaft;
generating fluid flow to offset the movement of the motor shaft; and
causing substantially zero movement of the motor shaft.

8. The hill hold control method of claim 7, wherein generating fluid flow to offset the movement of the motor shaft comprises:
determining a direction of fluid flow to offset movement of the motor shaft;
determining a magnitude of fluid flow to offset movement of the motor shaft; and
activating a pump to generate fluid flow in the determined direction and magnitude.

9. The hill hold control method of claim 7, further comprising:
maintaining substantially zero movement of the motor shaft by repeating the sensing movement; generating fluid flow and causing substantially zero movement steps.

10. The hill hold control method of claim 9, further comprising:
starting a brake timer when the neutral command is initially sensed;
comparing the brake timer to a brake delay value; and
when the brake timer is greater than the brake delay value:
activating the parking brake of the machine; and
discontinuing maintaining substantially zero movement of the motor shaft by repeating the sensing movement; generating fluid flow and causing substantially zero movement steps.

11. The hill hold control method of claim 10, further comprising:
resetting the brake timer to zero when the parking brake is released or the machine is commanded out of the neutral position.

12. The hill hold control method of claim 9, further comprising:
sensing when a parking brake is applied to the machine; and
when application of the parking brake is sensed; discontinuing maintaining substantially zero movement of the motor shaft by repeating the sensing movement; generating fluid flow and causing substantially zero movement steps.

13. The hill hold control method of claim 7, wherein sensing movement of a motor shaft comprises sensing the rotational speed of the motor shaft.

14. The hill hold control method of claim 13, wherein generating fluid flow to offset the movement of the motor shaft comprises:
determining a direction and magnitude of fluid flow as a function of the sensed rotational speed of the motor shaft.

15. The hill hold control method of claim 14, further comprising:
maintaining substantially zero movement of the motor shaft by repeating the sensing movement; generating fluid flow and causing substantially zero movement steps.

16. The hill hold control method of claim 15, further comprising:
sensing when a parking brake is applied to the machine; and
when application of the parking brake is sensed; discontinuing maintaining substantially zero movement of the motor shaft by repeating the sensing movement; generating fluid flow and causing substantially zero movement steps.

17. The hill hold control method of claim 16, further comprising:
starting a brake timer when the neutral command is initially sensed;
comparing the brake timer to a brake delay value; and
when the brake timer is greater than the brake delay value:
activating the parking brake of the machine; and
discontinuing maintaining substantially zero movement of the motor shaft by repeating the sensing movement; generating fluid flow and causing substantially zero movement steps.

18. The hill hold control method of claim 17, further comprising:
resetting the brake timer to zero when the parking brake is released or the machine is commanded out of the neutral position.

19. A hill hold control method for a closed loop transmission of a machine, the hill hold control method comprising:
sensing a neutral command for the transmission; and
performing the following steps while the neutral command is sensed:
starting a brake timer when the neutral command is initially sensed;
sensing movement of a motor shaft;
generating fluid flow to offset the movement of the motor shaft and cause substantially zero movement of the motor shaft;
comparing the brake timer to a brake delay value;
when the brake timer is greater than the brake delay value, activating the parking brake of the machine and discontinuing the step of generating fluid flow to offset the movement of the motor shaft;
sensing when a parking brake is applied to the machine; and
when application of the parking brake is sensed; discontinuing the step of generating fluid flow to offset the movement of the motor shaft.

20. The hill hold control method of claim 19, wherein sensing movement of a motor shaft comprises sensing the rotational speed of the motor shaft; and wherein the step of generating fluid flow to offset the movement of the motor shaft comprises:
determining a direction and magnitude of fluid flow as a function of the sensed rotational speed of the motor shaft; and
adjusting the direction and magnitude of fluid flow based on recurring readings of the sensed rotational speed of the motor shaft.
